(19) United States
(12) Patent Application Publication
(10) Pub. No.: US 2026/0209490 A1
(43) Pub. Date: Jul. 23, 2026

(54) NON-FLUORINATED HYDROPHOBIC THERMOPLASTIC COMPOSITIONS CONTAINING FATTY ACID ESTER AND ARTICLES FORMED THEREFROM

(71) Applicant: Avient Corporation, Avon Lake, OH (US)

(72) Inventors: Jian Zhou, Avon, OH (US); Benjamin Messmore, Bay Village, OH (US); Ryan Divens, Naples, FL (US); Nicholas DeLucia, Mayfield Heights, OH (US); Robert J. Opalko, Middleburg Heights, OH (US)

(73) Assignee: Avient Corporation, Avon Lake, OH (US)

(21) Appl. No.: 19/140,603

(22) PCT Filed: Dec. 18, 2023
(86) PCT No.: PCT/US2023/084548

§ 371 Date: Jun. 18, 2025

Related U.S. Application Data
(60) Provisional application No. 63/433,568, filed on Dec. 19, 2022.

(51) Int. Cl. C08L 23/12; B29C 45/00; C08K 5/09; C08K 5/103

(52) U.S. Cl. CPC C08L 23/12; B29C 45/0001; C08K 5/09; C08K 5/103; C08K 2201/019; C08L 2205/03; C08L 2666/66

(57) ABSTRACT

Thermoplastic compositions comprise non-fluorinated hydrophobic additive comprising fatty acid ester, hydrolysis stabilizer comprising at least one of polycarbodiimides and polyester-modified siloxanes, and thermoplastic polymer. The combination of the non-fluorinated hydrophobic additive and the hydrolysis stabilizer results in thermoplastic compositions having improved hydrophobicity and/or enhanced durability of hydrophobicity while also being free of fluorine and fluorinated substances.

### CLAIM OF PRIORITY

This application claims priority from U.S. Provisional Patent Application Ser. No. 63/433,568 bearing Attorney Docket Number 1202222-US-F and filed on Dec. 19, 2022, which is hereby incorporated by reference in its entirety.

### TECHNICAL FIELD

The present disclosure relates to non-fluorinated hydrophobic thermoplastic compositions. More particularly, non-fluorinated hydrophobic thermoplastic compositions include non-fluorinated hydrophobic additive and hydrolysis stabilizer, providing improved hydrophobicity and/or enhanced durability of hydrophobicity of the thermoplastic compositions while also being free of fluorine and fluorinated substances.

### BACKGROUND

Thermoplastic articles having hydrophobic properties (i.e., water-repelling performance) are desirable for many end-use applications across a variety of industries. Conventionally, hydrophobic properties may be imparted to thermoplastic articles by using fluorinated surfactants as functional additives. More recently, however, demand is growing for non-fluorinated alternatives in view of environmental concerns with certain categories of fluorinated compounds like per- and polyfluoroalkyl substances (PFAS). However, conventional non-fluorinated alternatives may not provide the desired level of hydrophobicity and/or durability of hydrophobicity.

Accordingly, a need exists for non-fluorinated thermoplastic compositions having increased hydrophobicity and/or enhanced durability of hydrophobicity.

### SUMMARY

Embodiments of the present disclosure are directed to non-fluorinated hydrophobic thermoplastic compositions, articles formed from the thermoplastic compositions, and related systems and methods.

According to some embodiments, a thermoplastic composition is provided. The thermoplastic composition comprises: (a) non-fluorinated hydrophobic additive comprising fatty acid ester; (b) hydrolysis stabilizer comprising at least one of polycarbodiimides and polyester-modified siloxanes; and (c) thermoplastic polymer; wherein the thermoplastic composition is free of fluorine and fluorinated substances.

According to other embodiments, a thermoplastic article is provided. The thermoplastic article is formed from the thermoplastic composition as disclosed herein, wherein the thermoplastic article is free of fluorine and fluorinated substances.

According to further embodiments, a multilayer article is provided. The multilayer article comprises (a) an outer layer formed from the thermoplastic composition as disclosed herein; and (b) an inner layer formed from a material excluding the thermoplastic composition; wherein the multilayer article is free of fluorine and fluorinated substances.

According to even further embodiments, a system is provided. The system comprises (a) a component formed from the thermoplastic composition as disclosed herein, wherein the component is free of fluorine and fluorinated substances; and (b) an aqueous liquid in physical contact with at least a portion of the component.

According to other embodiments, a method of imparting hydrophobicity to a surface of a thermoplastic article is provided. The method comprises the step of forming the thermoplastic article from the thermoplastic composition as disclosed herein, wherein the thermoplastic article is free of fluorine and fluorinated substances.

Additional features and advantages of this and other embodiments will be set forth in the detailed description which follows, and in part will be readily apparent to those skilled in the art from the detailed description or recognized by practicing the embodiments described herein, including the detailed description and the claims, which follow.

### DETAILED DESCRIPTION

Reference is made hereinafter to various embodiments of non-fluorinated hydrophobic thermoplastic compositions, articles formed therefrom, and related systems and methods.

The disclosure should not be construed as limited to the embodiments set forth herein. Rather, these embodiments are provided so that this disclosure will be thorough and complete, and will fully convey the subject matter to those skilled in the art.

### Definitions

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the term “hydrophobicity” refers the tendency of a surface of a material (or an article formed from the material) to repel water (i.e., water-repelling performance).

As used herein, the term “ambient conditions” refers to a temperature of 23+/−2° C. and a relative humidity of 50+/−10%.

As used herein, the term “ambient aging” refers to aging of a material in an air-conditioned laboratory environment at ambient conditions (i.e., 23+/−2° C. and a relative humidity of 50+/−10%) for 240+/−2 hours according to ASTM D618.

As used herein, the term “heat aging” refers to aging of a material in an air-circulating oven that maintains air temperature of 75+/−2° C. and a relative humidity of between 2% and 6% for 120+/−2 hours. The air-circulating oven has a constant horizontal air draft that exchanges the air in the oven for minimum 5 times per hour. After the heat oven exposure, the material is then cooled in an air-conditioned lab environment with 23+/−2° C. and 50+/−10% relative humidity for at least 4 hours prior to testing.

As used herein, the term “durability of hydrophobicity” refers to a retention of hydrophobicity of a material after heat aging. It may be quantified by a difference in the hydrophobicity of the material after heat aging relative to the hydrophobicity of the material after ambient aging only. A smaller absolute difference indicates a better durability of hydrophobicity.

As used herein, the term “formed from” (including related terms such as “forming”) refers to, with respect to an article (or component of an article) and a thermoplastic material, that the article (or component of the article) is extruded, molded, shaped, pressed, or otherwise made, in whole or in part, from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the terms “free of fluorine and fluorinated substances” and “non-fluorinated” refer to a component or a material or an article wherein, in embodiments, no amounts of fluorine and/or fluorinated substances are intentionally added; or, in embodiments, no amounts of fluorine and/or fluorinated substances are detectable using conventional means of detection; or, in embodiments, no amounts of fluorine and/or fluorinated substances are present.

As used here, the term “haze” refers to the percentage of light scattered as it passes through a material as measured according to ASTM D1003 at a specimen thickness of 0.8 mm.

As used herein, the term “masterbatch formulation” refers to a thermoplastic composition that is a concentrated mixture of one or more additives dispersed in a carrier and may be used by blending it at a certain rate or proportion (i.e., let-down) into typically a relatively higher proportion of a neat thermoplastic polymer base resin during a process of forming a final thermoplastic article in order to impart one or more desired properties to the final thermoplastic article. In the fields of thermoplastic compounding and thermoplastic article manufacturing, an additive masterbatch formulation may also be referred to as an additive concentrate formulation. In a masterbatch formulation, the carrier may be the same as or different from the thermoplastic polymer as described herein below for use in the thermoplastic composition as disclosed herein (i.e., the major thermoplastic polymer used for forming a final thermoplastic article). A suitable carrier may be solid or liquid. Non-limiting examples of a suitable carrier may include linear low-density polyethylene, polyethylene wax, polybutadiene, ethylene vinyl acetate copolymers, and ethylene methyl acrylate copolymers. The carrier may have a lower melt viscosity than that of the major thermoplastic polymer used for forming the final thermoplastic article in order to achieve a good dispersion of the functional additives present in the masterbatch formulation throughout the thermoplastic polymer matrix of the final thermoplastic article.

As used herein, the term “ready-for-forming formulation” refers to a thermoplastic composition that may be used as provided (i.e., without further blending with an additive masterbatch formulation or neat additives) to form a final thermoplastic article having one or more desired properties. In the fields of thermoplastic compounding and thermoplastic article manufacturing, a ready-for-forming formulation may also be referred to as a pre-compounded thermoplastic formulation, a thermoplastic molding or extrusion compound, or other names.

As used herein, the term “residual dye” refers to a value corresponding to the amount of dye remaining on the surfaces of a specimen material as determined according to the residual dye test. A lower residual dye value indicates a higher level of hydrophobicity.

As used herein, the term “residual dye test” refers to the procedures of the residual dye test as described in the Examples herein below, which includes the procedures for (a) conditioning of plaques, (b) preparing dye test solution and calibration curve between the absorbance and dye concentration, and (c) dipping and UV-VIS test procedure or gravimetric test procedure; each as described in the Examples.

As used herein, the term “transmittance” refers to the percentage of light that passes through a material as measured according to ASTM D1003 at a specimen thickness of 0.8 mm.

### Usefulness

As discussed hereinabove, thermoplastic articles having hydrophobic properties (i.e., water-repelling performance) are desirable for many end-use applications across a variety of industries. Conventionally, hydrophobic properties may be imparted to thermoplastic articles by using fluorinated surfactants as functional additives. More recently, however, there is growing demand for non-fluorinated alternatives in view of environmental concerns with certain categories of fluorinated compounds like per- and polyfluoroalkyl substances (PFAS).

Potential alternatives to fluorinated surfactants include other known surfactants. For example, U.S. Pat. No. 11,008,439 to Brown et al. (“Brown”) describes the use of certain hydrophobic cyclic sugar alcohol derivatives as polymer resin additives to provide repellency surface effects to finished solid articles. Sorbitan tristearate is used in Example 1 of Brown.

When sorbitan tristearate is used as an additive, it is possible to impart, at least initially, desirable hydrophobicity levels to thermoplastic articles. However, the hydrophobicity levels imparted by sorbitan tristearate are not durable, especially when it is used at relatively lower loading levels. Indeed, upon heat aging, the hydrophobicity levels can severely deteriorate. Brown fails to recognize this problem.

The thermoplastic compositions and articles as disclosed herein address the aforementioned problems. In particular, it has been found that thermoplastic compositions that include a combination of non-fluorinated hydrophobic additive comprising fatty acid ester and hydrolysis stabilizer comprising at least one of polycarbodiimides and polyester-modified siloxanes may have improved hydrophobicity and/or enhanced durability of hydrophobicity while also being free of fluorine and fluorinated substances.

Accordingly, the thermoplastic compositions as disclosed herein may be used to make any thermoplastic article that requires improved hydrophobicity and/or enhanced durability of hydrophobicity without the use of fluorinated compounds. The thermoplastic compositions as disclosed herein are especially useful for making thermoplastic articles for laboratory plasticware applications including but not limited to beakers, bottles, containers, dishes, flasks, funnels, jars, pipettes, pipette tips, tubes, vials, and the like; and medical and/or personal care and/or personal protection applications including but not limited to gowns, drapes, curtains, dressings, aprons, coverings, pads, and the like.

### Thermoplastic Composition

Thermoplastic compositions as disclosed herein comprise (a) non-fluorinated hydrophobic additive; (b) hydrolysis stabilizer; and (c) thermoplastic polymer. The hydrophobic additive comprises fatty acid ester. The hydrolysis stabilizer comprises at least one of polycarbodiimides and polyester-modified siloxanes. The thermoplastic compositions are free of fluorine and fluorinated substances. The combination of the non-fluorinated hydrophobic additive and the hydrolysis stabilizer results in thermoplastic compositions having improved hydrophobicity or enhanced durability of hydrophobicity while also being free of fluorine and fluorinated substances.

In embodiments, the thermoplastic composition may be a masterbatch formulation or a ready-for-forming formulation.

In embodiments in which the thermoplastic composition is a masterbatch formulation, loading levels of the different ingredients may vary based on factors including but not necessarily limited to intended let-down ratio, intended loading levels of the different ingredients in ready-for-forming formulation, and target performance properties of thermoplastic articles formed from the ready-for-forming formulation.

For example, in embodiments, the masterbatch formulation may comprise, based on a total weight of the thermoplastic composition, (a) non-fluorinated hydrophobic additive in an amount from about 5 wt. % to about 25 wt. %; (b) hydrolysis stabilizer in an amount from about 0.5 wt. % to about 25 wt. %; (c) thermoplastic polymer in an amount from about 40 wt. % to about 94.5 wt. %; and optionally (d) other additives in an amount from 0 wt. % to about 10 wt. %.

In embodiments in which the thermoplastic composition is a ready-for-forming formulation, loading levels of the different ingredients may vary based on factors including target performance properties of thermoplastic articles formed from the ready-for-forming formulation and which of the different types of hydrolysis stabilizer is used.

For example, in embodiments in which the thermoplastic composition is a ready-for-forming formulation and the hydrolysis stabilizer comprises a polycarbodiimide, the thermoplastic composition may comprise, based on a total weight of the thermoplastic composition: (a) non-fluorinated hydrophobic additive in an amount from about 0.5 wt. % to about 10 wt. %; (b) hydrolysis stabilizer in an amount from about 0.1 wt. % to about 2.5 wt. %; (c) thermoplastic polymer in an amount from about 47.5 wt. % to about 99.4 wt. %; and (d) optionally, other additives in an amount from 0 wt. % to about 40 wt. %; wherein the hydrolysis stabilizer comprises a polycarbodiimide; and wherein the non-fluorinated hydrophobic additive and the hydrolysis stabilizer are present at a weight ratio from about 100:1 to about 4:1.

For further example, in embodiments in which the thermoplastic composition is a ready-for-forming formulation and the hydrolysis stabilizer comprises a polyester-modified siloxane, the thermoplastic composition may comprise, based on a total weight of the thermoplastic composition: (a) non-fluorinated hydrophobic additive in an amount from about 0.5 wt. % to about 10 wt. %; (b) hydrolysis stabilizer in an amount from about 0.1 wt. % to about 10 wt. %; (c) thermoplastic polymer in an amount from about 40 wt. % to about 99.4 wt. %; and (d) optionally, other additives in an amount from 0 wt. % to about 40 wt. %; wherein the hydrolysis stabilizer comprises a polyester-modified siloxane; and wherein the non-fluorinated hydrophobic additive and the hydrolysis stabilizer are present at a weight ratio from about 10:1 to about 1:2.

In embodiments, a specimen film formed from the thermoplastic composition may have a static water contact angle of at least about 102 degrees according to ASTM D5946.

### Non-Fluorinated Hydrophobic Additive

Thermoplastic compositions as disclosed herein comprise non-fluorinated hydrophobic additive comprising fatty acid ester. The non-fluorinated hydrophobic additive is included to impart hydrophobicity to the thermoplastic composition and articles formed therefrom.

Suitable non-fluorinated hydrophobic additive may include conventional or commercially available non-fluorinated hydrophobic additive comprising fatty acid ester. One type of non-fluorinated hydrophobic additive comprising fatty acid ester may be used alone or in combination with one or more other types of non-fluorinated hydrophobic additive comprising fatty acid ester.

In embodiments, the fatty acid ester is a reaction product of a polyol and at least two fatty acids. In embodiments, the polyol may comprise one or more selected from sorbitan, pentaerythritol, and glycerol. In embodiments, each of the at least two fatty acids may have a structure of R—COOH, wherein R is independently selected from linear or branched alkyl having about 5 to about 29 carbons.

In embodiments, the non-fluorinated hydrophobic additive may comprise one or more selected from sorbitan tristearate, sorbitan distearate, sorbitan trioleate, sorbitan dioleate, sorbitan tripalmitate, sorbitan dipalmitate, sorbitan trilaurate, sorbitan dilaurate, pentaerythritol tetrastearate, glyceryl tristearate, glyceryl distearate, glyceryl trioleate, glyceryl dioleate, glyceryl tripalmitate, glyceryl dipalmitate, glyceryl trilaurate, and glyceryl dilaurate.

In embodiments in which the thermoplastic composition is a masterbatch formulation, the thermoplastic composition may comprise the non-fluorinated hydrophobic additive in an amount from about 5 wt. % to about 25 wt. %, based on a total weight of the thermoplastic composition. For example, in embodiments, the amount of the non-fluorinated hydrophobic additive may be greater than or equal to about 5 wt. %, greater than or equal to about 7 wt. %, greater than or equal to about 10 wt. %, greater than or equal to about 13 wt. %, or greater than or equal to about 15 wt. %; and less than or equal to about 25 wt. %, less than or equal to about 23 wt. %, less than or equal to about 20 wt. %, or less than or equal to about 17 wt. %; further, in embodiments, from about 5 wt. % to about 25 wt. %, from about 5 wt. % to about 23 wt. %, from about 5 wt. % to about 20 wt. %, from about 5 wt. % to about 17 wt. %, from about 7 wt. % to about 25 wt. %, from about 7 wt. % to about 23 wt. %, from about 7 wt. % to about 20 wt. %, from about 7 wt. % to about 17 wt. %, from about 10 wt. % to about 25 wt. %, from about 10 wt. % to about 23 wt. %, from about 10 wt. % to about 20 wt. %, from about 10 wt. % to about 17 wt. %, from about 13 wt. % to about 25 wt. %, from about 13 wt. % to about 23 wt. %, from about 13 wt. % to about 20 wt. %, from about 13 wt. % to about 17 wt. %, from about 15 wt. % to about 25 wt. %, from about 15 wt. % to about 23 wt. %, from about 15 wt. % to about 20 wt. %, or from about 15 wt. % to about 17 wt. %, or any and all sub-ranges formed from any of these endpoints.

In embodiments in which the thermoplastic composition is a ready-for-forming formulation, the thermoplastic composition may comprise the non-fluorinated hydrophobic additive in an amount from about 0.5 wt. % to about 10 wt. %. For example, in embodiments, the amount of the non-fluorinated hydrophobic additive may be greater than or equal to about 0.5 wt. %, greater than or equal to about 1 wt. %, or greater than or equal to about 1.5 wt. %; and less than or equal to about 10 wt. %, less than or equal to about 8 wt. %, less than or equal to about 6 wt. %, less than or equal to about 4 wt. %, less than or equal to about 3 wt. %, or even less than or equal to about 2 wt. %; further, in embodiments, from about 0.5 wt. % to about 10 wt. %, from about 0.5 wt. % to about 8 wt. %, from about 0.5 wt. % to about 6 wt. %, from about 0.5 wt. % to about 4 wt. %, from about 0.5 wt. % to about 3 wt. %, from about 0.5 wt. % to about 2 wt. %, from about 1 wt. % to about 10 wt. %, from about 1 wt. % to about 8 wt. %, from about 1 wt. % to about 6 wt. %, from about 1 wt. % to about 4 wt. %, from about 1 wt. % to about 3 wt. %, from about 1 wt. % to about 2 wt. %, from about 1.5 wt. % to about 10 wt. %, from about 1.5 wt. % to about 8 wt. %, from about 1.5 wt. % to about 6 wt. %, from about 1.5 wt. % to about 4 wt. %, from about 1.5 wt. % to about 3 wt. %, or from about 1.5 wt. % to about 2 wt. %, or any and all sub-ranges formed from any of these endpoints.

In embodiments, the non-fluorinated hydrophobic additive may have a hydrophilic-lipophilic balance (HLB) value less than 3, less than 2.5, or even less than 2.2.

Suitable commercial embodiments of the non-fluorinated hydrophobic additive are available under the SPAN brand from Croda, such as grades 65 or 85, which have HLB values less than 3. SPAN 65 (so called “sorbitan tristearate”) and SPAN 85 (so called “sorbitan trioleate”) are produced by reacting sorbitol (a polyol) and corresponding fatty acids as described in U.S. Pat. No. 6,362,353B1. Such an esterification reaction generally produces a mixture of mono-esters, di-esters, and tri-esters, wherein higher esters (e.g., tri-esters) are desired, and some of the fatty acid may not react with the sorbitan and will remain as (nominally) free acid in the synthesis product. It is also generally difficult to separate lower esters from higher esters in the final product. SPAN 65 is believed to be a mixture of sorbitan tristearate, sorbitan distearate, sorbitan monostearate, and residue free fatty acids, wherein the tristearate content is more than about 70 wt. % and the monostearate content is less than about 8 wt. % based on the total weight of the mixture. Neat sorbitan tristearate (although not commercially available) has a calculated HLB value of 2.1 while neat sorbitan monostearate has a calculated HLB value of 4.7 which is much more hydrophilic than the tristearate. Therefore, to lower the HLB value of SPAN 65 or a similar commercial product like SPAN 65 (being a mixture), the monostearate content should be minimized and the tristearate content should be maximized as much as possible through its manufacturing process.

### Hydrolysis Stabilizer

Thermoplastic compositions as disclosed herein comprise hydrolysis stabilizer comprising at least one of polycarbodiimides and polyester-modified siloxanes. The hydrolysis stabilizer is included to help improve the durability of hydrophobicity of the thermoplastic composition when an article formed from the thermoplastic composition is subjected to environmental aging such as heat aging.

Suitable hydrolysis stabilizer may include conventional or commercially available hydrolysis stabilizer comprising at least one of polycarbodiimides and polyester-modified siloxanes. For example, in embodiments, suitable hydrolysis stabilizer comprising a polycarbodiimide may include one polycarbodiimide or a combination of different polycarbodiimides. Likewise, in embodiments, suitable hydrolysis stabilizer comprising a polyester-modified siloxane may include one polyester-modified siloxane or a combination of different polyester-modified siloxanes. Furthermore, in embodiments, suitable hydrolysis stabilizer may include combinations of polycarbodiimides and polyester-modified siloxanes.

However, surprisingly, not all types of hydrolysis stabilizers are suitable. For example, as demonstrated by the Examples herein below, durability of hydrophobicity remains relatively low when the hydrolysis stabilizer comprises multi-functional reactive copolymer with pedant epoxy groups (e.g., JONCRYL ADR 4468 available from BASF).

In embodiments in which the thermoplastic composition is a masterbatch formulation, the thermoplastic composition may comprise hydrolysis stabilizer in an amount from about 0.5 wt. % to about 25 wt. %, based on a total weight of the thermoplastic composition. For example, in embodiments, the amount of the hydrolysis stabilizer may be greater than or equal to about 0.5 wt. %, greater than or equal to about 1 wt. %, greater than or equal to about 3 wt. %, greater than or equal to about 5 wt. %, greater than or equal to about 7 wt. %, or greater than or equal to about 10 wt. %; and less than or equal to about 25 wt. %, less than or equal to about 23 wt. %, less than or equal to about 20 wt. %, less than or equal to about 17 wt. %, or than or equal to about 15 wt. %; further, in embodiments, from about 0.5 wt. % to about 25 wt. %, from about 0.5 wt. % to about 23 wt. %, from about 0.5 wt. % to about 20 wt. %, from about 0.5 wt. % to about 17 wt. %, from about 0.5 wt. % to about 15 wt. %, from about 1 wt. % to about 25 wt. %, from about 1 wt. % to about 23 wt. %, from about 1 wt. % to about 20 wt. %, from about 1 wt. % to about 17 wt. %, from about 1 wt. % to about 15 wt. %, from about 3 wt. % to about 25 wt. %, from about 3 wt. % to about 23 wt. %, from about 3 wt. % to about 20 wt. %, from about 3 wt. % to about 17 wt. %, from about 3 wt. % to about 15 wt. %, from about 5 wt. % to about 25 wt. %, from about 5 wt. % to about 23 wt. %, from about 5 wt. % to about 20 wt. %, from about 5 wt. % to about 17 wt. %, from about 5 wt. % to about 15 wt. %, from about 7 wt. % to about 25 wt. %, from about 7 wt. % to about 23 wt. %, from about 7 wt. % to about 20 wt. %, from about 7 wt. % to about 17 wt. %, from about 7 wt. % to about 15 wt. %, from about 10 wt. % to about 25 wt. %, from about 10 wt. % to about 23 wt. %, from about 10 wt. % to about 20 wt. %, from about 10 wt. % to about 17 wt. %, or from about 10 wt. % to about 15 wt. %, or any and all sub-ranges formed from any of these endpoints.

In embodiments in which the thermoplastic composition is a ready-for-forming formulation, loading levels of the different ingredients may vary based on factors including target performance properties of thermoplastic articles formed from the ready-for-forming formulation and which of the different types of hydrolysis stabilizer is used. More particularly, while not intending to be limited by theory, it is believed that the mechanism of the hydrolysis stabilizer comprising a polycarbodiimide may be different from that of the hydrolysis stabilizer comprising a polyester-modified siloxane. Accordingly, in order to provide improvements to the durability of hydrophobicity as disclosed herein, loading level ranges of the hydrolysis stabilizer may be different in the ready-for-forming composition depending on which of the different types of hydrolysis stabilizer is used.

In embodiments in which the thermoplastic composition is a ready-for-forming formulation and the hydrolysis stabilizer comprises a polycarbodiimide, the thermoplastic composition may comprise hydrolysis stabilizer in an amount from about 0.1 wt. % to about 2.5 wt. %, based on a total weight of the thermoplastic composition. For example, in embodiments, the amount of the hydrolysis stabilizer may be greater than or equal to about 0.1 wt. %, greater than or equal to about 0.2 wt. %, greater than or equal to about 0.5 wt. %, greater than or equal to about 0.8 wt. %, greater than or equal to about 1 wt. %, and greater than or equal to about 1.2 wt. %; and less than or equal to about 2.5 wt. %, less than or equal to about 2 wt. %, and less than or equal to about 1.8 wt. %; further, in embodiments, from about 0.1 wt. % to about 2.5 wt. %, from about 0.1 wt. % to about 2 wt. %, from about 0.1 wt. % to about 1.8 wt. %, from about 0.2 wt. % to about 2.5 wt. %, from about 0.2 wt. % to about 2 wt. %, from about 0.2 wt. % to about 1.8 wt. %, from about 0.5 wt. % to about 2.5 wt. %, from about 0.5 wt. % to about 2 wt. %, from about 0.5 wt. % to about 1.8 wt. %, from about 0.8 wt. % to about 2.5 wt. %, from about 0.8 wt. % to about 2 wt. %, from about 0.8 wt. % to about 1.8 wt. %, from about 1 wt. % to about 2.5 wt. %, from about 1 wt. % to about 2 wt. %, from about 1 wt. % to about 1.8 wt. %, from about 1.2 wt. % to about 2.5 wt. %, from about 1.2 wt. % to about 2 wt. %, from about 1.2 wt. % to about 1.8 wt. %, or any and all sub-ranges formed from any of these endpoints.

Furthermore, in embodiments in which the hydrolysis stabilizer comprises a polycarbodiimide, the non-fluorinated hydrophobic additive and the hydrolysis stabilizer may be present at a weight ratio from about 100:1 to about 4:1.

In embodiments in which the thermoplastic composition is a ready-for-forming formulation and the hydrolysis stabilizer comprises a polyester-modified siloxane, the thermoplastic composition may comprise hydrolysis stabilizer in an amount from about 0.1 wt. % to about 10 wt. %, based on a total weight of the thermoplastic composition. For example, in embodiments, the amount of the hydrolysis stabilizer may be greater than or equal to about 0.1 wt. %, greater than or equal to about 0.5 wt. %, greater than or equal to about 1 wt. %, greater than or equal to about 2 wt. %, and greater than or equal to about 4 wt. %, and less than or equal to about 10 wt. %, less than or equal to about 8 wt. %, and less than or equal to about 6 wt. %; further, in embodiments, from about 0.1 wt. % to about 10 wt. %, from about 0.1 wt. % to about 8 wt. %, from about 0.1 wt. % to about 6 wt. %, from about 0.5 wt. % to about 10 wt. %, from about 0.5 wt. % to about 8 wt. %, from about 0.5 wt. % to about 6 wt. %, from about 1 wt. % to about 10 wt. %, from about 1 wt. % to about 8 wt. %, from about 1 wt. % to about 6 wt. %, from about 2 wt. % to about 10 wt. %, from about 2 wt. % to about 8 wt. %, from about 2 wt. % to about 6 wt. %, from about 4 wt. % to about 10 wt. %, from about 4 wt. % to about 8 wt. %, from about 4 wt. % to about 6 wt. %, or any and all sub-ranges formed from any of these endpoints.

Furthermore, in embodiments in which the hydrolysis stabilizer comprises a polyester-modified siloxane, the non-fluorinated hydrophobic additive and the hydrolysis stabilizer may be present at a weight ratio from about 10:1 to about 1:2.

Suitable commercial embodiments of the hydrolysis stabilizer are available under the STABAXOL brand from Lanxess, such as polycarbodiimide grade P100; under the LUBIO brand from Schäfer-Additivsysteme GmbH, such as polycarbodiimide grade Hydrostab 2, and under the TEGOMER brand from Evonik, such as polyester-modified siloxane grade H-Si 6441 P.

### Thermoplastic Polymer

Thermoplastic compositions as disclosed herein comprise thermoplastic polymer. The thermoplastic polymer may be selected based on end-use applications for the thermoplastic compositions and/or target performance properties and criteria for thermoplastic articles formed from the thermoplastic compositions.

Suitable thermoplastic polymer may include conventional or commercially available thermoplastic polymer. One type of thermoplastic polymer may be used alone or in combination with one or more other type of thermoplastic polymer.

In embodiments, the thermoplastic polymer may comprise one or more selected from polyethylenes, polypropylenes, polyolefin copolymers, cyclic olefin copolymers, ethylene vinyl acetate copolymers, polymethylpentenes, polystyrenes, styrenic block copolymers, polyamides, and polyamide copolymers.

In embodiments, the polyethlyenes may comprise a polyethylene homopolymer (i.e., composed of ethylene monomers) or a polyethylene copolymer having greater than 50 wt. % ethylene monomer and an additional comonomer, such as C₃-C₁₂ alpha olefins.

In embodiments, the polypropylenes may comprise a polypropylene homopolymer (i.e., composed of propylene monomers) or a polypropylene copolymer having greater than 50 wt. % propylene monomer and an additional comonomer such as C₂ and C₄-C₁₂ alpha olefins.

In embodiments in which the thermoplastic composition is a masterbatch formulation, the thermoplastic composition may comprise thermoplastic polymer as the carrier in an amount from about 40 wt. % to about 94.5 wt. %, based on a total weight of the thermoplastic composition. For example, in embodiments, the amount of the thermoplastic polymer in the thermoplastic composition may be greater than or equal to about 40 wt. %, greater than or equal to about 50 wt. %, greater than or equal to about 60 wt. %, greater than or equal to about 70 wt. %, or greater than or equal to about 80 wt. %; and less than or equal to about 94.5 wt. %, less than or equal to about 90 wt. %, or less than or equal to 85 wt. %; further, in embodiments, from about 40 wt. % to about 94.5 wt. %, from about 40 wt. % to about 90 wt. %, from about 40 wt. % to about 85 wt. %, from about 50 wt. % to about 94.5 wt. %, from about 50 wt. % to about 90 wt. %, from about 50 wt. % to about 85 wt. %, from about 60 wt. % to about 94.5 wt. %, from about 60 wt. % to about 90 wt. %, from about 60 wt. % to about 85 wt. %, from about 70 wt. % to about 94.5 wt. %, from about 70 wt. % to about 90 wt. %, from about 70 wt. % to about 85 wt. %, from about 80 wt. % to about 94.5 wt. %, from about 80 wt. % to about 90 wt. %, or from about 80 wt. % to about 85 wt. %, or any and all sub-ranges formed from any of these endpoints.

In embodiments in which the thermoplastic composition is a masterbatch formulation, the thermoplastic polymer as the carrier may comprise one or more of linear low-density polyethylene, polyethylene wax, polybutadiene, ethylene vinyl acetate copolymers, and ethylene methyl acrylate copolymers.

In embodiments in which the thermoplastic composition is a ready-for-forming formulation, the thermoplastic composition may comprise thermoplastic polymer in an amount from about 40 wt. % to about 99.4 wt. %, based on a total weight of the thermoplastic composition. For example, in embodiments, the amount of the thermoplastic polymer in the thermoplastic composition may be, based on a total weight of the thermoplastic polymer, greater than or equal to about 40 wt. %, greater than or equal to about 45 wt. %, greater than or equal to about 47.5 wt. %, greater than or equal to about 50 wt. %, greater than or equal to about 52.5 wt. %, greater than or equal to about 60 wt. %, greater than or equal to about 70 wt. %, greater than or equal to about 80 wt. %, greater than or equal to about 90 wt. %, or greater than or equal to about 95 wt. %; and less than or equal to about 99.4 wt. %, less than or equal to about 99 wt. %, or less than or equal to about 98.5 wt. %; further, in embodiments, from about 40 wt. % to about 99.4 wt. %, from about 40 wt. % to about 99 wt. %, from about 40 wt. % to about 98.5 wt. %, from about 45 wt. % to about 99.4 wt. %, from about 45 wt. % to about 99 wt. %, from about 45 wt. % to about 98.5 wt. %, from about 47.5 wt. % to about 99.4 wt. %, from about 47.5 wt. % to about 99 wt. %, from about 47.5 wt. % to about 98.5 wt. %, from about 50 wt. % to about 99.4 wt. %, from about 50 wt. % to about 99 wt. %, from about 50 wt. % to about 98.5 wt. %, from about 52.5 wt. % to about 99.4 wt. %, from about 52.5 wt. % to about 99 wt. %, from about 52.5 wt. % to about 98.5 wt. %, from about 60 wt. % to about 99.4 wt. %, from about 60 wt. % to about 99 wt. %, from about 60 wt. % to about 98.5 wt. %, from about 70 wt. % to about 99.4 wt. %, from about 70 wt. % to about 99 wt. %, from about 70 wt. % to about 98.5 wt. %, from about 80 wt. % to about 99.4 wt. %, from about 80 wt. % to about 99 wt. %, from about 80 wt. % to about 98.5 wt. %, from about 90 wt. % to about 99.4 wt. %, from about 90 wt. % to about 99 wt. %, from about 90 wt. % to about 98.5 wt. %, from about 95 wt. % to about 99.4 wt. %, from about 95 wt. % to about 99 wt. %, or from about 95 wt. % to about 98.5 wt. %, or any and all sub-ranges formed from any of these endpoints.

Suitable commercial embodiments of the thermoplastic polymer are polypropylene homopolymers available under the PRO-FAX brand from LyondellBasell, such as polypropylene homopolymer grade PD702; from INEOS such as PP grade H35G; and from Braskem such as PP grade HP 648S.

### Synergistic Fatty Acid Additive

In embodiments in which the hydrolysis stabilizer comprises a polycarbodiimide, thermoplastic compositions as disclosed herein may further comprise a synergistic fatty acid additive. As demonstrated by the Examples below, the synergistic fatty acid additive may be included to help improve both the initial hydrophobicity and the durability of hydrophobicity of the thermoplastic composition when an article formed from the thermoplastic composition is subjected to environmental aging such as heat aging.

In embodiments, the synergistic fatty acid additive may include fatty acids having a structure of R′—COOH, wherein R′ is selected from (a) linear and unsaturated alkyl with a C═C bond in cis configuration, or (b) branched and saturated alkyl, and wherein each of (a) and (b) has about 11 to about 29 carbons.

Non-limiting examples of synergistic fatty acid additive include fatty acid that is linear and unsaturated, such as erucic acid, and fatty acid that is branched and saturated, such as isostearic acid.

In embodiments, the thermoplastic composition may comprise synergistic fatty acid additive in an amount from about 0.1 wt. % to about 3 wt. %, based on a total weight of the thermoplastic composition. For example, in embodiments, the amount of the synergistic fatty acid additive in the thermoplastic composition may be, based on a total weight of the thermoplastic polymer, greater than or equal to about 0.1 wt. %, greater than or equal to about 0.2 wt. %, greater than or equal to about 0.5 wt. %, or greater than or equal to about 1 wt. %; and less than or equal to about 3 wt. %, less than or equal to about 2.5 wt. %, less than or equal to about 2.5 wt. %, less than or equal to about 2.0 wt. %; further, in embodiments, from about 0.1 wt. % to about 3 wt. %, from about 0.1 wt. % to about 2.5 wt. %, from about 0.1 wt. % to about 2 wt. %, from about 0.2 wt. % to about 3 wt. %, from about 0.2 wt. % to about 2.5 wt. %, from about 0.2 wt. % to about 2 wt. %, from about 0.5 wt. % to about 3 wt. %, from about 0.5 wt. % to about 2.5 wt. %, from about 0.5 wt. % to about 2 wt. %, from about 1 wt. % to about 3 wt. %, from about 1 wt. % to about 2.5 wt. %, from about 1 wt. % to about 2 wt. %, or any and all sub-ranges formed from any of these endpoints.

### Other Additives

In embodiments, thermoplastic compositions as disclosed herein may further comprise one or more optional other additives.

Suitable other additives may include conventional or commercially available plastics additives. Those skilled in the art of thermoplastics compounding, without undue experimentation, may select suitable additives from available references, for example, E.W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance of the material or article formed therefrom.

Non-limiting examples of optional other additives may include one or more of antioxidants; nucleating agents; colorants (e.g., pigments and/or dyes); inorganic mineral fillers; mineral oils, flame retardants; glass beads, glass flakes, and glass fibers; impact modifiers; micas; slip and anti-blocking agents; ultraviolet light absorbers; and waxes.

In embodiments in which the thermoplastic composition is a masterbatch formulation, the thermoplastic composition may comprise other additives in an amount from 0 wt. % to about 10 wt. %, based on a total weight of the thermoplastic composition. For example, in embodiments, the amount of the other additives in the thermoplastic composition may be greater than or equal to 0 wt. %, greater than or equal to about 1 wt. %, or greater than or equal to about 3 wt. %; and less than or equal to about 10 wt. %, less than or equal to about 7 wt. %, or less than or equal to about 5 wt. %; further, in embodiments, from 0 wt. % to about 10 wt. %, from 0 wt. % to about 7 wt. %, from 0 wt. % to about 5 wt. %, from about 1 wt. % to about 10 wt. %, from about 1 wt. % to about 7 wt. %, from about 1 wt. % to about 5 wt. %, from about 3 wt. % to about 10 wt. %, from about 3 wt. % to about 7 wt. %, or from about 3 wt. % to about 5 wt. %, or any and all sub-ranges formed from any of these endpoints.

In embodiments in which the thermoplastic composition is a ready-for-forming formulation, the thermoplastic composition may comprise other additives in an amount from 0 wt. % to about 40 wt. %, based on a total weight of the thermoplastic composition. For example, in embodiments, the amount of the other additives in the thermoplastic composition may be greater than or equal to 0 wt. %, greater than or equal to about 1 wt. %, greater than or equal to 5 wt. %, or greater than or equal to 10 wt. %; and less than or equal to about 40 wt. %, less than or equal to about 30 wt. %, or less than or equal to about 20 wt. %; further, in embodiments, from 0 wt. % to about 40 wt. %, from 0 wt. % to about 30 wt. %, from 0 wt. % to about 20 wt. %, from about 1 wt. % to about 40 wt. %, from about 1 wt. % to about 30 wt. %, from about 1 wt. % to about 20 wt. %, from about 5 wt. % to about 40 wt. %, from about 5 wt. % to about 30 wt. %, from about 5 wt. % to about 20 wt. %, from about 10 wt. % to about 40 wt. %, from about 10 wt. % to about 30 wt. %, or from about 10 wt. % to about 20 wt. %, or any and all sub-ranges formed from any of these endpoints.

It should be understood that suitable loading levels of the other additives may depend on the type(s) of the other additives that are used. For example, upper endpoints such as 40 wt. %, 30 wt. % or 20 wt. % may be more typically applicable for other additives such as inorganic mineral fillers and glass beads, glass flakes, and/or glass fibers, and less typically applicable or not applicable for other additives such as antioxidants.

### Processing

In embodiments, thermoplastic compositions as disclosed herein may be made with a batch process or a continuous process.

In embodiments, components of the thermoplastic composition, including non-fluorinated hydrophobic additive, hydrolysis stabilizer, thermoplastic polymer, and, optionally, other additives, may be added to an extruder and melt-mixed. In embodiments, the melt-mixing (e.g., in the barrel of the extruder) may be carried out at a temperature from about 210° C. to about 230° C.

Non-limiting examples of processing techniques are described in available references, for example, Dominick V. Rosato et al., Plastics Design Handbook (Springer 2013).

### Thermoplastic Article

Thermoplastic compositions as disclosed herein may be used to form any thermoplastic article that requires improved hydrophobicity and/or enhanced durability of hydrophobicity without the use of fluorinated compounds. Accordingly, thermoplastic articles may be formed from the thermoplastic compositions as disclosed herein, and the thermoplastic articles may be free of fluorine and fluorinated substances.

In embodiments, at least a portion of the non-fluorinated hydrophobic additive may be present at an outer surface of the thermoplastic article in an amount sufficient to provide a desirable level of hydrophobicity on the outer surface both before and after the thermoplastic article is subjected to environmental aging such as heat aging. Further, in embodiments, at least a portion of the hydrolysis stabilizer may be present at the outer surface of the thermoplastic article along with at least a portion of the non-fluorinated hydrophobic additive.

In embodiments, the non-fluorinated hydrophobic additive may be intermixed throughout the thermoplastic article because the non-fluorinated hydrophobic additive is incorporated into the thermoplastic composition used for forming the thermoplastic article. Likewise, in embodiments, at least a portion of the hydrolysis stabilizer may be intermixed throughout the thermoplastic article because the hydrolysis stabilizer is incorporated into the thermoplastic composition used for forming the thermoplastic article.

In embodiments, neither the non-fluorinated hydrophobic additive nor the hydrolysis stabilizer is applied to the thermoplastic article as a surface coating or surface treatment composition as a separate or subsequent step after the thermoplastic article is formed.

In embodiments, the thermoplastic article may be formed from the thermoplastic composition into a useful form by one or more processes selected from extrusion, injection molding, blow molding, extrusion coating, rotational molding, spinning, thermoplastic pultrusion, and thermoforming.

In embodiments, the thermoplastic article may be a useful form selected from fibers; films and sheets; laminates; nonwoven fabrics; pellets; and three-dimensional formed parts.

In embodiments, the thermoplastic article may be laboratory plasticware or a component thereof. For example, in embodiments, the laboratory plasticware is one or more selected from beakers, bottles, containers, dishes, flasks, funnels, jars, pipettes, pipette tips, tubes, vials, etc.

In embodiments, the thermoplastic article may have one or both of a haze of less than or equal to about 70% and a transmittance of greater than or equal to about 85%, each according to ASTM D1003 and at a specimen thickness of 0.8 mm. A relatively low haze (e.g., less than or equal to about 70%) and/or a relatively high transmittance (e.g., greater than or equal to about 85%) may be desired in certain applications. For example, in laboratory plasticware applications such as pipette tips, it is desirable to see through the thermoplastic article to see the amount of liquid contained therein.

In embodiments, the thermoplastic article may be a medical article and/or personal care article and/or personal protection article or a component thereof. For example, in embodiments, the medical article and/or personal care article and/or personal protection article is one or more selected from gowns, drapes, curtains, dressings, aprons, coverings, pads, etc.

### Multilayer Article

Multilayer articles may be formed from the thermoplastic compositions as disclosed herein. The multilayer articles may be free of fluorine and fluorinated substances.

In embodiments, multilayer articles as disclosed herein may comprise an outer layer formed from the thermoplastic composition disclosed herein and an inner layer formed from a material excluding the thermoplastic composition.

In embodiments, the outer layer may be a thermoplastic article as disclosed herein.

### System

Systems as disclosed herein may comprise a component formed from the thermoplastic composition described herein in combination with an aqueous liquid in physical contact with at least a portion of the component.

In embodiments, the component may be a thermoplastic article and/or multilayer article as disclosed herein.

In embodiments, the aqueous liquid may comprise one or more bodily fluids or secretions such as blood, urine, saliva, etc. In further embodiments, the aqueous liquid may comprise or pharmaceutical compositions or testing/diagnostic/reagent compositions.

### Method of Imparting Hydrophobicity

Methods of imparting hydrophobicity to a surface of a thermoplastic article may comprise the step of forming the thermoplastic article from the thermoplastic composition described herein.

In embodiments, the method imparts improved hydrophobicity and/or enhanced durability of hydrophobicity to the surface of the thermoplastic article.

### Examples

Non-limiting examples of various embodiments of the disclosed invention are provided.

Table 1 below shows sources of ingredients used to form Comparative Examples C1 to C4 and Examples E1 to E3.

TABLE 1

| Ingredient | Chemical Description | Brand and Grade | Source |
|---|---|---|---|
| Thermoplastic polymer | Polypropylene homopolymer | PRO-FAX PD702 | LyondellBasell |
| Non-fluorinated | Mixture of sorbitan tristearate, | SPAN 65 | Croda |
| hydrophobic additive | sorbitan distearate, sorbitan | | |
| | monostearate, and residue free acid | | |
| | with less than 8 wt. % monostearate | | |
| | content | | |
| Hydrolysis stabilizer | Multifunctional reactive copolymer | JONCRYL ADR | BASF |
| (comparative example) | with pedant epoxy groups | 4468 | |
| Hydrolysis stabilizer | Polycarbodiimide | STABAXOL P100 | Lanxess |
| Hydrolysis stabilizer | Polyester-modified siloxane | TEGOMER H-Si | Evonik |
| | | 6441 P | |
| Synergistic fatty acid | Erucic acid | [none] [referred to | Multiple |
| additive (optional) | | as ERUCIC | |
| | | ACID] | |

Preparation of masterbatch formulations—For each of Comparative Examples C2 to C₄ and Examples E1 to E3, an masterbatch formulation comprising ten times (10×) the final concentration of corresponding additives as listed in Table 2 and PRO-FAX PD702 (polypropylene homopolymer) carrier resin were intermixed thoroughly and extruded using a co-rotating twin-screw extruder with a 18 mm screw diameter, 40 length/screw diameter and moderate-shear screw design, and melt temperature between 210° C. to 230° C. Each masterbatch formulation was immediately cooled down and pelletized after exiting the twin-screw extruder.

Let-down of the additive concentrate formulation and injection molding process—Each additive concentrate formulation was premixed with neat PRO-FAX PD702 resin using a weight ratio of 10:90. The premix was fed into the injection molding machine, melted, and molded into flat plaques having dimensions of 100 mm×100 mm×0.8 mm and smooth surfaces on both sides of the plaque. The final concentrations of the additives in the plaque form of each let-down formulation are consistent with those of each example as listed in Table 2. The melt temperature of the injection molding process was controlled between 220° C. to 250° C. for all the examples. The molded plaques were then cut into 100 mm long×25 mm wide plaques of the same thickness as test specimen for the residual dye test.

### Residual Dye Test

Conditioning of plaques—The plaque samples of each example composition were conditioned at ambient conditions for 240+/−2 hours or at 75+/−2° C. for 120+/−2 hours as indicated in Table 2.

Preparation of dye test solution and calibration curve between the absorbance and dye concentration—5 mL of food-grade green dye concentrate liquid (Fisher Science Education, Catalog #S05376) and 55 mL of deionized (DI) water were stirred to mix the dye concentrate an form a homogenous test solution. A portion of the test solution was diluted into concentrations between 0.4 μL/mL and 0.1 μL/mL (dye concentrate volume/total volume of the solution) by adding additional DI water and at least 3 concentration levels within the above dilution range. UV-Vis spectra of each diluted solution was collected using a UV-Vis spectrometer. A calibration curve was created using the absorption band present at 415 nm (i.e., one of the characteristic absorption bands of the green dye solution) by plotting absorbance at 415 nm versus concentrations of the diluted solutions and conducting a linear regression. A R-Squared value of greater than 0.99 was obtained for the linear regression, which is consistent with the Beer-Lambert law.

Dipping and UV-Vis test procedure—The green dye test solution was poured into a flat bottom beaker to an about 60 mm tall liquid level. The top edge of a flat plaque specimen of 100 mm long×25 mm wide×0.8 mm thick was held with the length direction of the plaque along the vertical direction. The plaque was vertically dipped into the test solution in the beaker and the bottom edge of the specimen was rested on the bottom of the beaker, such that the immersion depth of the specimen was about 60 mm. The plaque was pulled vertically and completely out of the test solution in the beaker with a speed between 125 mm/s to 250 mm/s. The specimen was held steadily and vertically above the beaker while waiting for the liquid film at the sample surfaces to complete de-wetting and also for the droplets accumulated at the bottom edge of the plaque to drip under their own weight back into the beaker. The plaque containing the residue liquid on its flat surfaces was placed into a second dry beaker and 10 mL of DI water (5 mL per side of the plaque) was dispensed to adequately rinse the dye from the plaque. A homogenous liquid sample of the rinsed off solution in the second beaker was collected and the sample's UV-Vis spectra and absorbance value at 415 nm were collected. This process was repeated for two additional plaque specimens for each example formulation and aging condition. The absorbance of the three total plaque specimens were averaged.

Residue liquid determined by a gravimetric test procedure—The UV-vis method to quantify the residue liquid may be less convenient to use because it requires a UV-vis calibration curve for specific dyes used in the test. As such, different dye solutions may require different calibration curves because of differences in absorption coefficients between dyes. An alternative approach to quantify the amount of the residue liquid on the sample surface after the sample surface's exposure to the liquid is a gravimetric method. This method does not require a dye in the test fluid although dye was still used in the applicable examples below as visual assistance to see where the residue liquid was located on the surface after the dipping step. To perform the gravimetric method, 5 replicate flat plaque specimens were prepared with smooth surfaces and size of 100 mm long×75 mm wide×0.8 mm thick. The plaque specimens were conditioned at ambient condition for 240 hours or at 75° C. for 120 hours (i.e., sample aging condition). A fresh test liquid (a green dye water solution was used as test fluid in the examples of this invention) was prepared. The initial total weight of 5 dry plaque specimen was weighed. Like the dipping step described above with the UV-Vis procedure, each specimen was dipped and then pulled at moderate speed (a speed between 125 mm/s to 250 mm/s) out of the test liquid. The wet specimen was transferred into a secondary dry beaker, and the total weight of the 5 wet specimen (with residue liquid on their surfaces) was weighed after deducting the weight of the dry beaker. From the difference between the dry and wet weights of the 5 specimen, the averaged amount of residue liquid per specimen (in unit of miligram/plaque) was measured and reported for the sample tested under the specific aging condition.

Table 2 below shows the formulations (in wt. %, based on a total weight of the thermoplastic composition) used to form and test results for Comparative Examples C1 to C₄ and Examples E1 to E3.

TABLE 2

| Example | | C1 | C2 | C3 | C4 |
|---|---|---|---|---|---|
| Ingredients | | | | | |
| PRO-FAX PD702 | | 100 | 98.4 | 98.0 | 97.75 |
| SPAN 65 | | — | 1.6 | 2.0 | 2.0 |
| JONCRYL ADR 4468 | | — | — | — | 0.25 |
| STABAXOL P100 | | — | — | — | — |
| TEGOMER H-Si 6441 P | | — | — | — | — |
| Total | | 100 | 100 | 100 | 100 |
| Test Results | | | | | |
| Property | Aging Condition | | | | |
| Residual dye | 240 hours at ambient condition | 0.5 | 0.0 | 0.1 | 0.1 |
| (UV-Vis method) | 120 hours at 75° C. | 0.9 | 0.4 | 0.4 | 0.4 |
| | Difference | +0.4 | +0.4 | +0.3 | +0.3 |
| Transmittance (%) | 240 hours at ambient condition | 89.0 | 89.5 | 89.2 | 87.8 |
| | 120 hours at 75° C. | 86.0 | 86.1 | 88.3 | 87.7 |
| | Difference | −3.0 | −3.4 | −0.9 | −0.1 |
| Haze (%) | 240 hours at ambient condition | 47.3 | 40.5 | 42.5 | 46.5 |
| | 120 hours at 75° C. | 47.7 | 46.2 | 48.4 | 49.1 |
| | Difference | +0.4 | +5.7 | +5.9 | +2.6 |

| Example | | E1 | E2 | E3 |
|---|---|---|---|---|
| Ingredients | | | | |
| PRO-FAX PD702 | | 98.2 | 97.8 | 97.0 |
| SPAN 65 | | 1.6 | 2.0 | 2.0 |
| JONCRYL ADR 4468 | | — | — | — |
| STABAXOL P100 | | 0.2 | 0.2 | — |
| TEGOMER H-Si 6441 P | | — | — | 1.0 |
| Total | | 100 | 100 | 100 |
| Test Results | | | | |
| Property | Aging Condition | | | |
| Residual dye | 240 hours days at ambient | 0.0 | 0.1 | 0.1 |
| (UV-Vis method) | condition | | | |
| | 120 hours at 75° C. | 0.0 | 0.1 | 0.2 |
| | Difference | 0.0 | 0.0 | +0.1 |
| Transmittance (%) | 240 hours at ambient | 89.5 | 89.1 | 88.2 |
| | condition | | | |
| | 120 hours at 75° C. | 87.3 | 87.4 | 86.3 |
| | Difference | −2.2 | −1.7 | −1.9 |
| Haze (%) | 240 hours at ambient | 51.4 | 49.6 | 44.0 |
| | condition | | | |
| | 120 hours at 75° C. | 51.7 | 58.1 | 48.1 |
| | Difference | +0.3 | +8.5 | +4.1 |

Examples E1 to E3, thermoplastic compositions including PRO-FAX PD702 (thermoplastic polymer), SPAN 65 (non-fluorinated hydrophobic additive), and STABAXOL P100 or TEGOMER H-Si 6441 P (hydrolysis stabilizer), had a lower amount of residual dye after conditioning for 240 hours at ambient condition than Comparative Example C1, a thermoplastic composition including PRO-FAX PD702. As exemplified by Examples E1 to E3 and Comparative Example C1, thermoplastic compositions including both non-fluorinated hydrophobic additive and hydrolysis stabilizer have a greater hydrophobicity than thermoplastic compositions that do not include non-fluorinated hydrophobic additive and hydrolysis stabilizer.

Examples E1 to E3, thermoplastic compositions including PRO-FAX PD702 (thermoplastic polymer), SPAN 65 (non-fluorinated hydrophobic additive), and STABAXOL P100 (polycarbodiimide) or TEGOMER H-SI 6441P (polyester-modified siloxane) as hydrolysis stabilizer had lower amount of residual dye after conditioning for 120 hours at 75° C. than Comparative Examples C2 to C4, thermoplastic compositions including PRO-FAX PD702 and SPAN 65 without hydrolysis stabilizer or including PRO-FAX PD702, SPAN 65, JONCRYL ADR 4468 (multi-functional reactive copolymer with pedant epoxy groups) as hydrolysis stabilizer. The change or difference in residual dye between the sample conditioned at 75° C. for 120 hours and the same composition conditioned at ambient condition for 240 hours was less for Examples E1 to E3 as compared to Comparative Example C2 to C4. As exemplified by Examples E1 to E3 and Comparative Examples C2 to C4, thermoplastic compositions including either polycarbodiimide hydrolysis stabilizer or polyester-modified siloxane as hydrolysis stabilizer have a greater durability of hydrophobicity than thermoplastic compositions without hydrolysis stabilizer or thermoplastic compositions including multifunctional reactive copolymer with pedant epoxy groups as hydrolysis stabilizer.

Note that the transmittance and haze values of the examples after conditioning at 75° C. for 120 hours did not differ greatly from the transmittance and haze values after conditioning at ambient condition for 240 hours.

Table 3 below shows the formulations (in wt. %, based on a total weight of the thermoplastic composition) used to form and test results for Comparative Examples C1 and C5 to C6 and Examples E4 to E5, using the gravimetric method as described above to measure the residue liquid on the surface of each sample conditioned at ambient temperature (23° C.) for 240 hours or at 75° C. for 120 hours.

TABLE 3

| | | Example | | | | |
|---|---|---|---|---|---|---|
| Ingredients | | C1 | C5 | C6 | E4 | E5 |
| PRO-FAX PD702 | | 100 | 96 | 98.67 | 95.8 | 94.67 |
| SPAN 65 | | — | 4 | — | 4 | 4 |
| ERUCIC ACID | | — | — | 1 | — | 1 |
| STABAXOL P100 | | — | — | 0.33 | 0.2 | 0.33 |
| Total | | 100 | 100 | 100 | 100 | 100 |
| Test Results | | Example | | | | |
| Property | Aging Condition | C1 | C5 | C6 | E4 | E5 |
| Residual dye | 240 hours at ambient condition | 53 | 5 | 89 | 7 | 5 |
| (gravimetric | 120 hours at 75° C. | 82 | 15 | 79 | 11 | 5 |
| method) | Difference | +28 | +10 | −10 | +4 | 0 |

Example E4, a thermoplastic composition including PRO-FAX PD702 (thermoplastic polymer), SPAN 65 (hydrophobic additive), and STABAXOL P100 (hydrolysis stabilizer), had a similar amount of residual liquid after conditioning for 240 hours at ambient temperature compared to Comparative Example C5, a thermoplastic composition including PRO-FAX PD702 and SPAN 65 only. But, after both samples were conditioned for 120 hours at 75° C., E4 showed a lower amount of residual liquid than C5 (i.e., less difference in amount of residue liquid after heat aging versus before heat aging), indicating that E4 has a better durability of hydrophobic performance than C5.

Example E5, a thermoplastic compositions including PRO-FAX PD702, SPAN 65, STABAXOL P100, and erucic acid (an unsaturated fatty acid), had a significantly lower amount of residual liquid than both Comparative Example C5, a thermoplastic composition including PRO-FAX PD702 and SPAN 65 only and Comparative Example C6, a thermoplastic composition including PRO-FAX PD702, STABAXOL P100, and erucic acid (of the same loadings as those in E5) but no SPAN 65. E5 showed the best hydrophobic performance in both ambient and heat-aged conditions. Without intending to be limited by any theory, it is believed that erucic acid molecules present in Example E5 were able to migrate effectively to the sample surface and their carboxylic acid head groups also reacted with the carbodiimide groups of STABAXOL P100 at the sample surface during the heat aging. Accordingly, it is believed that the chemical reaction of erucic acid with STABAXOL P100 anchors erucic acid molecules to the sample surface, which would minimize its loss into the hot air in the heat aging oven due to potential volatile nature of erucic acid. Such potential interaction between the erucic acid and STABAXOL P100 at the sample surface had a surprisingly synergistic effect along with SPAN 65 which also likely interacted with the STABAXOL P100 additive at the sample surface so that a very durable hydrophobic performance after heating aging was seen for Example E5 versus Example E4 which does not contain erucic acid. In contrast, Comparative Example C6 which does not have SPAN 65 in its composition showed very poor hydrophobic performance for the both sample conditions before and after heat aging.

In view of above, it is further believed that a branched and saturated fatty acid such as isostearic acid may also work synergistically with SPAN 65 (a multifunctional fatty acid ester) and STABAXOL P100 (a polycarbodiimide) because the branched and saturated fatty acid can also effectively migrate to the surface and react with polycarbodiimide additive. A linear and saturated fatty acid (e.g., stearic acid), which is generally a slower migrating additive in thermoplastic compounds, is unlikely to have as good synergistic effect as erucic acid or isostearic. The amount of the fatty acid as a synergist additive should not be too high (e.g., more than 3 wt. % of the total composition) because the free fatty acid which is unreacted with polycarbodiimide on the sample surface may become leachable in the end-use applications.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects. The present disclosure extends to equivalents of aspects expressly described herein, all of which are considered to be within the scope of the present disclosure and covered by the following claims.

1. A thermoplastic composition comprising:
(a) non-fluorinated hydrophobic additive comprising fatty acid ester;
(b) hydrolysis stabilizer comprising at least one of polycarbodiimides and polyester-modified siloxanes; and
(c) thermoplastic polymer;
wherein the thermoplastic composition is free of fluorine and fluorinated substances.

2. The thermoplastic composition of claim 1, wherein the fatty acid ester is a reaction product of a polyol and at least two fatty acids.

3. The thermoplastic composition of claim 2, wherein the polyol comprises one or more selected from the group consisting of sorbitan, pentaerythritol, and glycerol.

4. The thermoplastic composition of claim 2, wherein each of the at least two fatty acids has a structure of R—COOH, wherein R is independently selected from linear or branched alkyl having about 5 to about 29 carbons.

5. The thermoplastic composition of claim 1, wherein the non-fluorinated hydrophobic additive comprises one or more selected from the group consisting of sorbitan tristearate, sorbitan distearate, sorbitan trioleate, sorbitan dioleate, sorbitan tripalmitate, sorbitan dipalmitate, sorbitan trilaurate, sorbitan dilaurate, pentaerythritol tetrastearate, glyceryl tristearate, glyceryl distearate, glyceryl trioleate, glyceryl dioleate, glyceryl tripalmitate, glyceryl dipalmitate, glyceryl trilaurate, and glyceryl dilaurate.

6. The thermoplastic composition of claim 1, wherein the thermoplastic polymer comprises one or more selected from the group consisting of polyethylenes, polypropylenes, polyolefin copolymers, cyclic olefin copolymers, ethylene vinyl acetate copolymers, polymethylpentenes, polystyrenes, styrenic block copolymers, polyamides, and polyamide copolymers.

7. (canceled)

8. The thermoplastic composition of claim 1, wherein the thermoplastic composition is a ready-for-forming formulation comprising, based on a total weight of the thermoplastic composition:
(a) non-fluorinated hydrophobic additive in an amount from about 0.5 wt. % to about 10 wt. %;
(b) hydrolysis stabilizer in an amount from about 0.1 wt. % to about 2.5 wt. %;
(c) thermoplastic polymer in an amount from about 47.5 wt. % to about 99.4 wt. %; and
(d) optionally, other additives in an amount from 0 wt. % to about 40 wt. %;
wherein the hydrolysis stabilizer comprises a polycarbodiimide; and
wherein the non-fluorinated hydrophobic additive and the hydrolysis stabilizer are present at a weight ratio from about 100:1 to about 4:1.

9. The thermoplastic composition of claim 8, wherein the thermoplastic composition further comprises a synergistic fatty acid additive having a structure of R′—COOH, wherein R′ is selected from (a) a linear and unsaturated alkyl with a C═C bond in cis configuration, or (b) a branched and saturated alkyl, and wherein each of (a) and (b) has about 11 to about 29 carbons.

10. The thermoplastic composition of claim 9, wherein the synergistic fatty acid additive is present in an amount from about 0.1 wt. % to about 3 wt. %, based on a total weight of the thermoplastic composition.

11. The thermoplastic composition of claim 1, wherein the thermoplastic composition is a ready-for-forming formulation comprising, based on a total weight of the thermoplastic composition:
(a) non-fluorinated hydrophobic additive in an amount from about 0.5 wt. % to about 10 wt. %;
(b) hydrolysis stabilizer in an amount from about 0.1 wt. % to about 10 wt. %;
(c) thermoplastic polymer in an amount from about 40 wt. % to about 99.4 wt. %; and
(d) optionally, other additives in an amount from 0 wt. % to about 40 wt. %;
wherein the hydrolysis stabilizer comprises a polyester-modified siloxane; and
wherein the non-fluorinated hydrophobic additive and the hydrolysis stabilizer are present at a weight ratio from about 10:1 to about 1:2.

12. The thermoplastic composition of claim 1, wherein a specimen film formed from the thermoplastic composition has a static water contact angle of at least about 102 degrees according to ASTM D5946.

13. A thermoplastic article formed from the thermoplastic composition of claim 1, wherein the thermoplastic article is free of fluorine and fluorinated substances.

14. The thermoplastic article of claim 13, wherein the non-fluorinated hydrophobic additive is intermixed throughout the thermoplastic article.

15. The thermoplastic article of claim 13, wherein the thermoplastic article is formed from the thermoplastic composition into a useful form by one or more processes selected from extrusion, injection molding, blow molding, extrusion coating, rotational molding, spinning, thermoplastic pultrusion, and thermoforming.

16. The thermoplastic article of claim 13, wherein the thermoplastic article is a useful form selected from fibers; films and sheets; laminates; nonwoven fabrics; pellets; and three-dimensional formed parts.

17. (canceled)

18. The thermoplastic article of claim 13, wherein the thermoplastic article has one or both of a haze of less than or equal to about 70% and a transmittance of greater than or equal to about 85%, each according to ASTM D1003 and at a specimen thickness of 0.8 mm.

19. A multilayer article comprising:
(a) an outer layer formed from the thermoplastic composition of claim 1; and
(b) an inner layer formed from a material excluding the thermoplastic composition;
wherein multilayer article is free of fluorine and fluorinated substances.

20. A system comprising:
(a) a component formed from the thermoplastic composition of claim 1, wherein the component is free of fluorine and fluorinated substances; and
(b) an aqueous liquid in physical contact with at least a portion of the component.

21. The system of claim 20, wherein the aqueous liquid comprises one or more of blood, urine, and saliva.

22. A method of imparting hydrophobicity to a surface of a thermoplastic article, the method comprising the step of forming the thermoplastic article from the thermoplastic composition of claim 1, wherein the thermoplastic article is free of fluorine and fluorinated substances.
